(19) United States
(12) Patent Application Publication
(10) Pub. No.: US 2008/0072295 A1
(43) Pub. Date: Mar. 20, 2008

(54) Method and System for Authentication

(76) Inventors: Nathaniel Solomon Borenstein, Ann Arbor, MI (US); Michael Factor, Haifa (IL); Itzhack Goldberg, Hadera Israel (IL); Yotam Medini, Binyamina (IL); Kenneth Nagin, M.P. Hamovil (IL)

Correspondence Address: Stephen C. Kaufman;IBM CORPORATION, Intellectual Property Law Dept., P.O. Box 218, Yorktown Heights, NY, 10598, US

(21) Appl. No.: 11/533,544

(22) Filed: Sep. 20, 2006

(51) Int. Cl. H04L 9/32

(52) U.S. Cl. 726/4

(57) ABSTRACT

A method and system for authentication are provided for verifying a service provider and providing a secure session. The method carried out at the service provider (402) includes: starting (403) a session with a client (401); receiving a challenge (405) from the client (401); responding to the challenge with a response (408); and sending a key (408) to the client (401) in non-OCR format, wherein the key is used for the session between the client (401) and the service provider (402). The response to the challenge is known only to the client (401) and the service provider (402). The key is used by the client (401) to encrypt (412) all the communications with the service provider (402) in the session. The response and the key may be sent to an alternative channel previously supplied by the client (401).

### FIELD OF THE INVENTION

This invention relates to the field of authentication. In particular, the invention relates to authentication of a service provider to prevent phishing.

### BACKGROUND OF THE INVENTION

Phishing is the name given to faking web site or email appearance to look like it comes from a trusted sender, such as a bank or other financial service provider. The typical motivation for the fake email or website is to lure the user to provide highly sensitive information, including passwords and financial information, to steal a user's personal identity data and financial account credentials to gain access to the user's accounts or assets.

A common example of a phishing method is for a fraudster to send an official-looking email to a user with a “from” address modified to look like it comes from the user's service provider, such as the user's bank. The user may be asked to update their details and the user is asked to log on to the service provider's web site using an embedded link in the email. When a user clicks on the link, they are directed to a replica of the service provider's web site. When the user enters their login username and password or other sensitive information, the sensitive information is captured. The captured sensitive information enables the fraudsters to gain access to the user's accounts on the genuine service provider's web site.

The importance of preventing phishing cannot be overstated from the institutional and personal perspective. There are a number of known methods which are used or advocated to prevent phishing. For a comprehensive article which lists most of the existing ways to defend against phishing see the references http://www.securitydocs.com/library/3011 or http://www.antiphishing.org.

The problem of phishing does not have a single solution. Phishing is not a purely technical problem and fraudsters will keep coming up with new ways of attacking users, which will demand eternal vigilance on the part of service providers. The long-term control strategy is a combination of evolving technologies, policies, and user awareness.

### SUMMARY OF THE INVENTION

According to a first aspect of the present invention there is provided a method for authentication carried out at a service provider, comprising: starting a session with a client; receiving a challenge from the client; responding to the challenge with a response; and sending a key to the client in non-OCR format, wherein the key is used for the session between the client and the service provider. A non-OCR format is a format not easily readable by a computer.

The challenge and response may take the form of one of the following. The challenge from the client may have a response inherently known to the service provider which may change over time. The challenge and response may be generated by a computer algorithm known to the client and the service provider. The challenge and response may be generated by hardware tokens at the client and the service provider. The response may have previously been provided by the client during a registration procedure with the service provider.

In one embodiment, the response is made to an alternative channel of communication with the client previously provided by the client.

Starting a session with a client may include receiving a log in request from a client, and the method may include a client sending a password only when the key has been received by the client and the password is then encrypted with the key.

The response and the key may be provided together in non-OCR format. The key may be generated by the service provider at the time of the session and may be a password, code or encryption key. The key may give access to an alternative address for the service provider.

The method may include notifying the client by a first communication channel of the key, and sending to a second communication channel the non-OCR formatted key and the alternative address for the service provider.

According to a second aspect of the present invention there is provided a method for authentication carried out at a service provider, comprising: starting a session with a client; receiving a challenge from the client; and responding to the challenge with a response to an alternative communication channel previously supplied by the client.

According to a third aspect of the present invention there is provided a method for authentication carried out at a service provider, comprising: starting a session with a client; receiving a challenge from the client; responding to the challenge with a response; and sending an alternative address for the service provider to the client.

Sending an alternative address for the service provider may be through a trusted alternative channel. The alternative address may be provided uniquely for the client.

According to a fourth aspect of the present invention there is provided a computer program product stored on a computer readable storage medium for, comprising computer readable program code means for performing the steps of: starting a session with a client; receiving a challenge from the client; responding to the challenge with a response; and sending a key to the client in non-OCR format, wherein the key is used for the session between the client and the service provider.

According to a fifth aspect of the present invention there is provided a system for authentication including a server comprising: a receiving means for initiating a client session; a response generating mechanism; a key generator for a session key; a non-OCR formatter for formatting the key; a transmitting means for transmitting the response and the key to a client.

The response generating mechanism may take various forms including one of the following. The response generating mechanism may determine a response inherently known at the server. The response generating mechanism may include a computer algorithm known to a client and the server. The response generating mechanism may include a hardware token corresponding to a hardware token of a client. The response generating mechanism may include a store of responses previously provided by a client.

The response generating mechanism may respond to an alternative channel of communication with a client previously provided by the client.

The server may include an alternative address for a client session. The system may include a first communication channel for notifying the client of the key, and a second communication channel for sending a non-OCR formatted key and the alternative address for the service provider. The second communication channel may be a message means including a link to the alternative address for the service provider.

An aim of the invention is to exploit the service provider's response to a client to make it more difficult for a phishing impostor to impersonate the genuine service provider.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a schematic diagram of an environment in which a phishing attack may occur;

FIG. 2 is a block diagram of a computer system in which the present invention may be implemented;

FIG. 3 is a block diagram of a client system and a service provider system in accordance with the present invention; and

FIGS. 4A to 4D are flow diagrams of examples of methods in accordance with different aspects of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

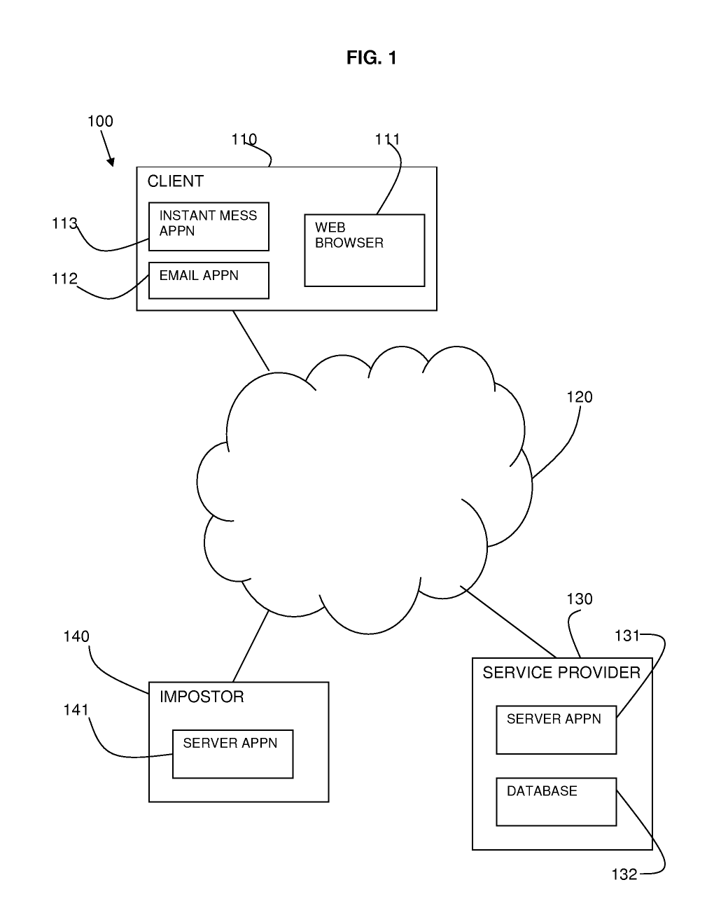

FIG. 1 shows a networked environment 100 in which a client computer system 110 has a web browser 111 for accessing the internet via a network 120. The client system 110 may also have an email application 112, an instant messaging 113 application and other forms of network communication. A service provider system 130 hosts a service on the internet. The service provider 130 provides a server application 131 and database 132 which may be accessed by a client. An impostor system 140 impersonates a service provider's server application 131 by providing a replica server application 141 with the aim of enticing a client to input sensitive information into the replica server application 141.

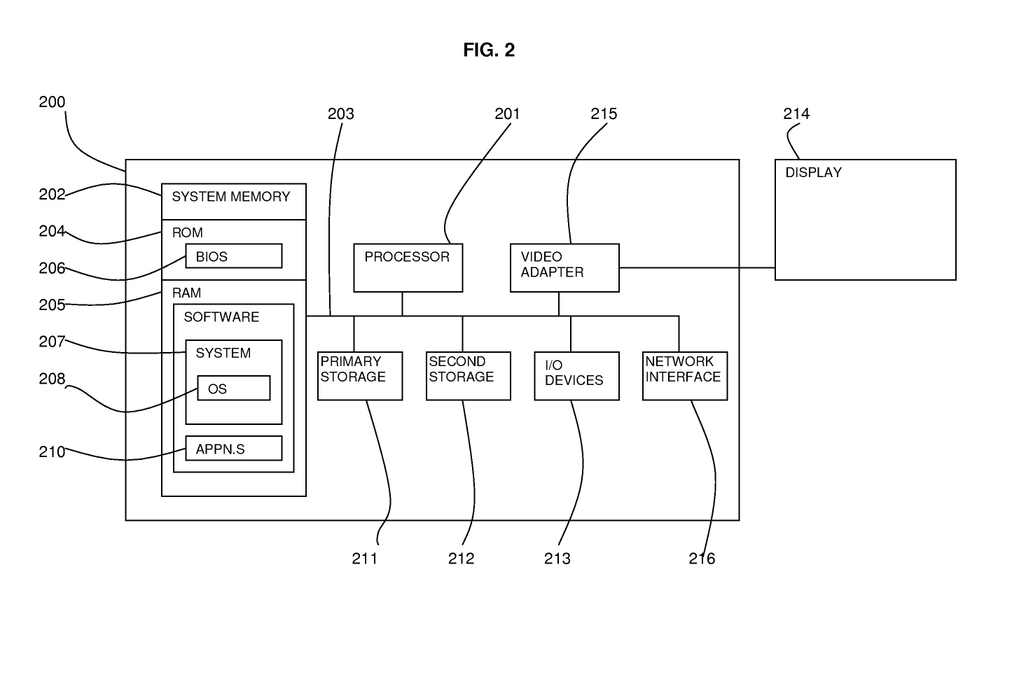

Referring to FIG. 2, exemplary client and service provider systems include a data processing system 200 suitable for storing and/or executing program code including at least one processor 201 coupled directly or indirectly to memory elements through a bus system 203. The memory elements can include local memory employed during actual execution of the program code, bulk storage, and cache memories which provide temporary storage of at least some program code in order to reduce the number of times code must be retrieved from bulk storage during execution.

The memory elements may include system memory 202 in the form of read only memory (ROM) 204 and random access memory (RAM) 205. A basic input/output system (BIOS) 206 may be stored in ROM 204. System software 207 may be stored in RAM 205 including operating system software 208. Software applications 210 may also be stored in RAM 205.

The system 200 may also include a primary storage means 211 such as a magnetic hard disk drive and secondary storage means 212 such as a magnetic disc drive and an optical disc drive. The drives and their associated computer-readable media provide non-volatile storage of computer-executable instructions, data structures, program modules and other data for the system 200. Software applications may be stored on the primary and secondary storage means 211, 212 as well as the system memory 202.

The computing system 200 may operate in a networked environment using logical connections to one or more remote computers via a network adapter 216.

Input/output devices 213 can be coupled to the system either directly or through intervening I/O controllers. A user may enter commands and information into the system 200 through input devices such as a keyboard, pointing device, or other input devices (for example, microphone, joy stick, game pad, satellite dish, scanner, or the like). Output devices may include speakers, printers, etc. A display device 214 is also connected to system bus 203 via an interface, such as video adapter 215.

There are many different methods used by impostors to impersonate genuine service providers. Methods and systems of authentication are described for enabling a client to ensure that a service provider is genuine.

The described methods and systems use challenge and response procedures to ensure that a service provider is genuine. The client can not or will not proceed with the transaction unless the proper response is returned by the service provider. Only the genuine provider can know the proper response and it very difficult for a non-genuine provider to mimic or learn the proper response. An additional or alternative aspect is also described in which the response includes an alternative channel through which the client continues further communication with the service provider.

The response from the service provider to a challenge by a client, is provided in a non-OCR format that can not easily be processed by a computer program. The data supplied in the non-OCR format is then used to encrypt all further communication between the client and the service provider. The non-OCR format is used to prevent a man-in-the-middle-attack in which the non-genuine service provider intercepts the client and service provider communication and is thus able to mimic their respective responses and read sensitive information.

OCR (optical character recognition) is computer software that is capable of translating data into machine-readable data. The data may be text, numbers, symbols, code, etc. Non-OCR format is data which is provided in a form which cannot be translated into machine-readable data and therefore is only meaningful to a human recipient. Data may be rendered in non-OCR format by a number of techniques. For example, letters may be distorted such that a human reader can identify them, but a computer would not recognize them. Another example is to add a background colour gradient to the data which confuses an OCR mechanism. Other systems uses look-alike characters in place of letters in text.

CAPTCHA (“completely automated public turing test to tell computers and humans apart” a trade mark of Carnegie Mellon University) is a challenge-response test used to determine whether or not the user is human. The described method and system uses non-OCR format to provide a human user with a key or some information without it being readable by intercepting computer mechanisms.

An embodiment of the described method is now described in which a challenge-response is carried out by the client and the service provider and the service provider supplies a security key that can not easily be read by a computer program.

The method has the purpose of forcing the alleged provider to prove that it is indeed the genuine provider and not a fake one. To that end, after the client provides his/her user name but before he/she gives the password, the service provider will be challenged with a question or questions that it would be difficult if not impossible for an impersonator to answer.

The answer (or algorithm) for a question is either inherently known or pre-stored at the service provider and thus would be very difficult for any but the genuine provider to know the proper response. If the “provider” cannot answer the question correctly then it can not be trusted.

The genuine service provider's response may be in a non-OCR format that can not easily be processed by computer program. Data provided in the non-OCR format is then used to encrypt all further communication between the client and service provider.

The challenge and response may take many different forms. The following are examples.
A response may only be inherently known by the genuine service provider. For example, a challenge may ask when the user last logged onto the system. Such an answer cannot be saved by the service provider and changes over time. Therefore, the answer cannot be obtained by an impostor.
A response may be provided by a user during an initial registration process. Such challenge-response questions are fairly common place and lack the security of an inherently known answer. For example, questions may include family names, childhood teacher's names, school names, etc.
A challenge-response may be generated using a computer algorithm known only to the user and the genuine service provider. A client has a secure function that generates an arbitrary string as the challenge and outputs the valid response. The service provider has a corresponding function or a database of valid responses and calculates the response.
A challenge-response may also be generated using computer hardware tokens. Hardware tokens are devices which generate a random response to a random challenge sequence. The service provider would need to have the hardware token in order to generate the correct response. The user supplies personalized decoders to its trusted suppliers, so only trusted providers can respond to the challenge correctly.
A response may be an alternative channel of communication that a user provided during an initial registration process. A challenge to a service provider may generate a response to the alternative client communication channel. The client then knows that the service provider is genuine.

A key or other information is sent by the service provider in non-OCR format, either at the same time as the response or separately, providing the user with a means to ensure that further communication with the proven genuine service provider is secure. The information may be, for example, an encryption key, a password, a method of encryption, an indication of an algorithm to use for encryption, or an alternative URL address.

In all of the above scenarios, the response may be provided in non-OCR format to ensure that the response is not intercepted. However, this is not essential if the response is sent separately from the key or other information as the response itself has no value to an impostor.

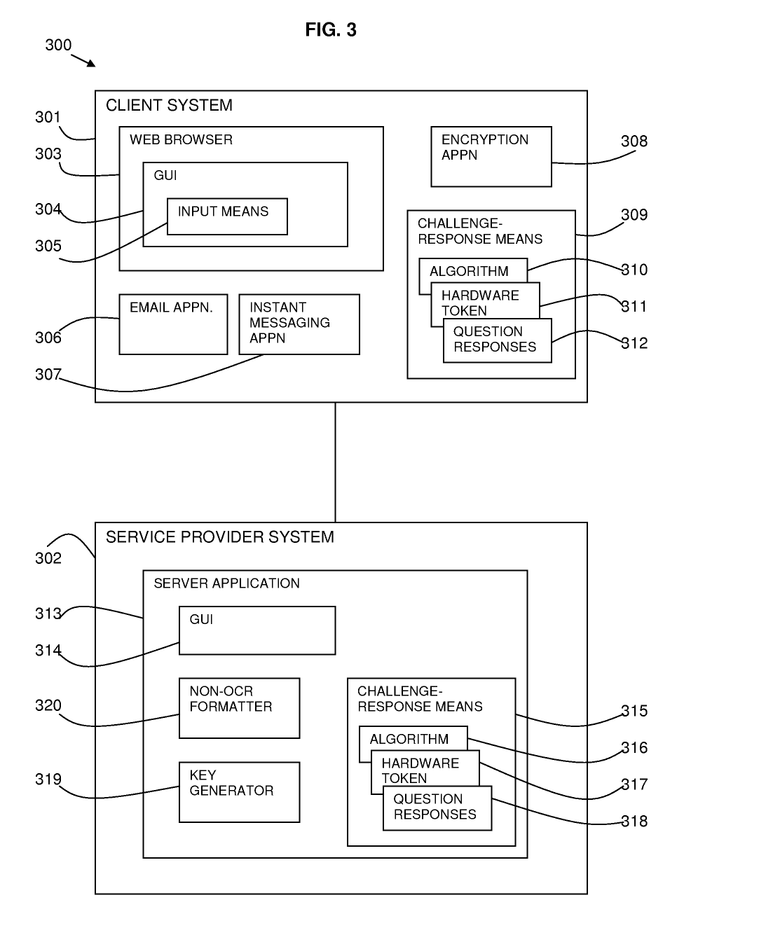

FIG. 3 shows a block diagram 300 of a client system 301 and a service provider system 302 showing components which may be provided to implement the described system.

The client system 301 has a web browser 303 including a graphical user interface (GUI) 304 with input means 305 for inputting data into accessed service providers on the internet. The client system 301 also has other communication channels such as an email application 306, an instant messaging application 307. An encryption application 308 is provided for encrypting communications from the client system 301. The client system 301 also includes a challenge-response generating means 309 for generating a challenge for a service provider 302 and generating the response to compare with the received response from the service provider 302. The challenge-response generating means 309 may be one of a computer algorithm 310, a hardware token 311, or previously provided information 312.

The service provider system 302 includes a server application 313 including a graphical user interface 314. A challenge-response generating mechanism 315 is provided corresponding to that of the client system 301. The challenge-response generating mechanism 315 may be one of a computer algorithm 316, a hardware token 317, or previously provided information 318.

The service provider system 302 also includes a key generator 319 and non-OCR formatter 320.

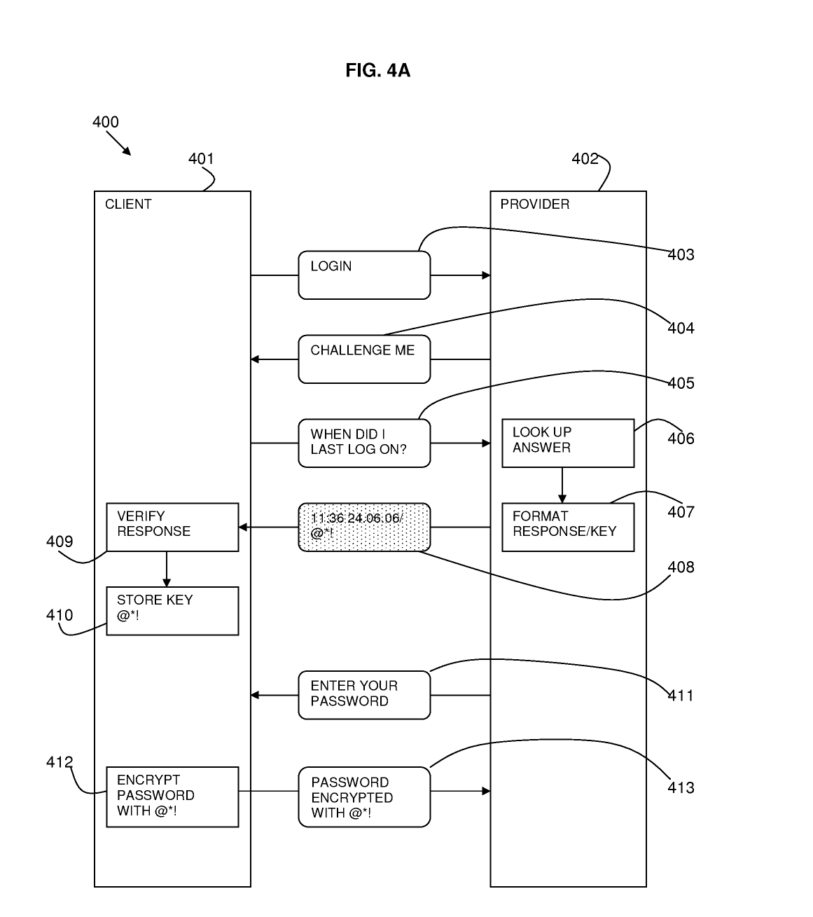

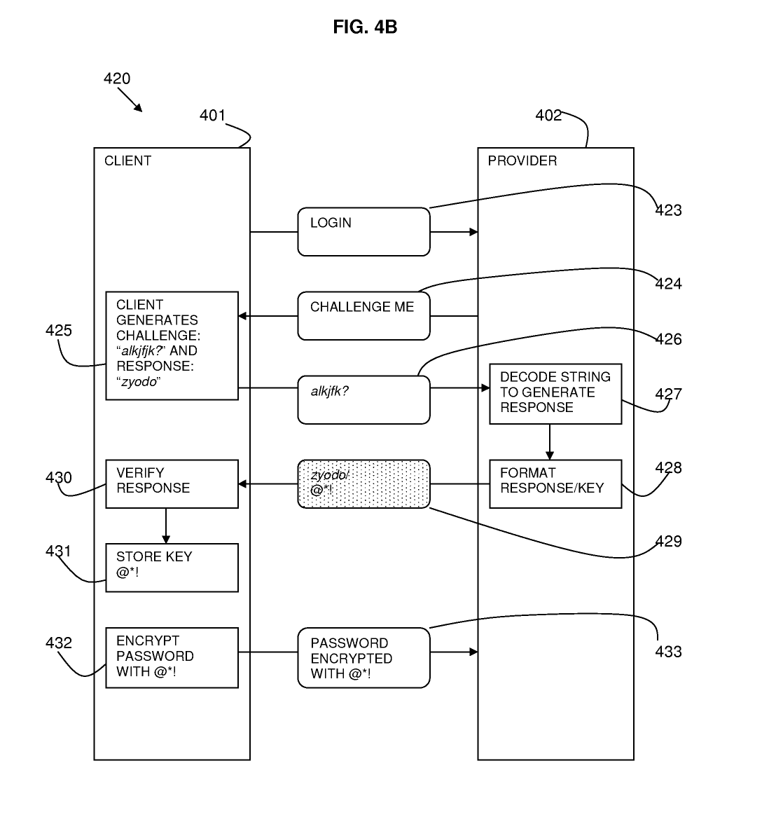

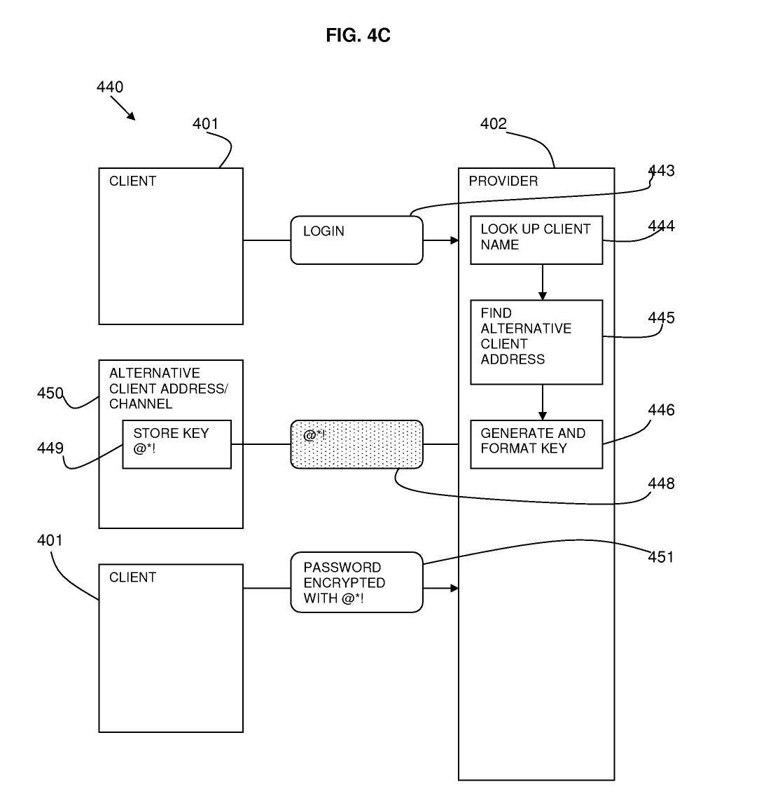

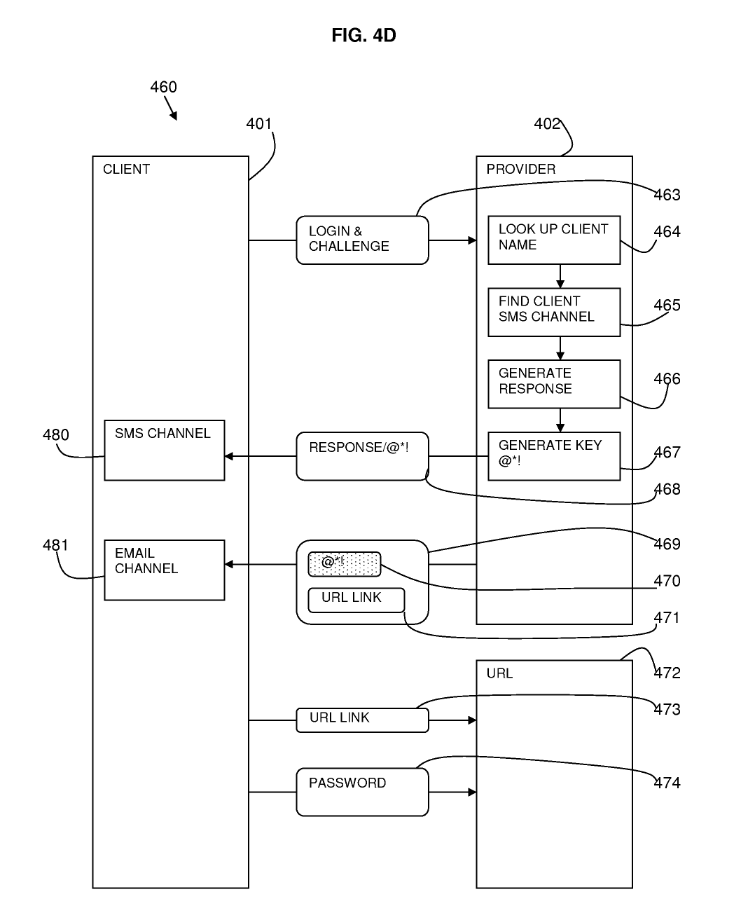

Referring to FIG. 4A a first example embodiment is shown in the form of a schematic flow diagram 400 between a client 401 and a service provider 402. The client 401 challenges the service provider 402 with a human natural language challenge.

A client 401 logs into a service provider's web site by entering a user name 403. The service provider 402 requests 404 that the client 401 issues a challenge. The client 401 presents a question in human natural language 405. The service provider 402 looks up the answer 406. The service provider 402 provides the response 407 to the client 401.

For example, the question may be “When did I last log on?” in which case the service provider 402 looks up user records to find the last log on time for the user. As the genuine system will be the only one to answer such a question correctly, the answer would give a good measure of confidence in the service provider's authenticity.

The response together with a key (which may be a randomly generated sequence) is formatted 407 in a non-OCR format (shown in the figure as a shaded block 408) to send it to the client 401. The response and the key may be sent separately, in which case both or only the key may be formatted in non-OCR format.

The client 401 receives the response and verifies 409 that it is correct. This may be by checking the client system's records or from the human user's knowledge. The non-OCR formatted key is also received by the client 401. The human user at the client 401 reads the key and stores 410 the key. The client 401 uses this key for all further communications with the service provider 402 in this session.

The service provider 402 may request 411 that the client 401 provides a password. The client 401 encrypts 412 the password with the key and sends the encrypted password 413 to the service provider 402. This password ensures that the client 401 is the genuine owner of the user name as provided in the log in 403 and the encryption with the key proves that the client 401 is a human user and not an intercepting software mechanism.

FIG. 4B shows a second example embodiment in the form of a schematic flow diagram 420 between a client 401 and a service provider 402. The client 401 challenges the service provider 402 with a computed challenge.

A client 401 logs into a service provider's web site by entering a user name 423 as in FIG. 4A. The service provider 402 requests 424 that the client 401 issues a challenge. In this embodiment, the client 401 has a secure function 425 that generates an arbitrary string for their challenge 426. The function 425 also outputs the valid response to the challenge so that the user can verify if the service provider's response is correct. Only the genuine provider knows how to decode the string 426 and respond correctly.

The service provider 402 decodes 427 the string 426 and generates the response. The response and a key are formatted 428 in a non-OCR format (shown as a shaded block 429) to the client 401. The client 401 verifies 430 the response. The human user of the client 401 reads the key and stores 431 it for further use. The client 401 uses the key to encrypt 432 further communications to the service provider 402 such as sending the client's password 433.

There are a number of known functions or algorithms that may be used by a client and service provider to generate computer challenges.

FIG. 4C shows a third example embodiment in the form of a schematic flow diagram 440 between a client 401 and a service provider 402. The client 401 has an alternative response channel pre-registered with the genuine service provider 402.

A client 401 logs into a service provider's web site by entering a user name 443 as in FIGS. 4A and 4B. The service provider 402 looks up 444 the client user name and finds 445 the alternative client address registered by the client 401 during a previous initial client registration procedure. The service provider 402 also generates a key and formats 446 the key in non-OCR format.

The service provider 402 sends the key in non-OCR format (shown as a shaded block 448) to the alternative client address 450. The alternative client address need not be on the same communication medium as the initiating client address. For example, the initiating client could be an IP host on the web and the alternative client could be a telephone number (SMS), an instant messaging address, or an email address.

The further communication between the client 401 and the service provider 402 may be carried out on the original initiating client channel or the alternative channel. However, the further communication is from the client 401 is required to be encrypted with the key. Therefore, the client 401 must be a human user to determine the non-OCR formatted key and must have received the key at the alternative address 450.

The client 401 receives the key and stores 449 the key for future use. The client 401 supplies a password 451 encrypted with the key to the service provider. This last prompt for and entering of a password, is an optional feature. The user may be interested only on authentication of the provider-site and not in a second authentication of oneself (after initial login). The use of the key received at the alternative address authenticates the client.

This method establishes an authentication protocol where the addresses associated with client initiation and acknowledgement differ. The client initiates a connection to a provider, but the provider acknowledges the connection to a different client address before the initiating client provides any secure information about themselves. The provider's acknowledgement contains a non-OCR formatted message that is used to encrypt all further communication between the client and service provider.

The acknowledgement client address belongs to a different physical host than the client host that initiates the connection to the provider. The acknowledgement client address is provided by the customer as part of initial registration and thus could only be known by a genuine provider. Also, since it belongs to a different physical host it provides protection from the case where the real client is infected with an impostor that listens for acknowledgements.

FIG. 4D shows a fourth example embodiment in the form of a schematic flow diagram 460 between a client 401 and a service provider 402. The client 401 has alternative response channels and the genuine service provider 402 has an alternative URL site.

A client 401 introduces himself to the service provider 402 and issues a challenge 463. The service provider 402 looks up the client user name 464, finds a first communication channel 465 (for example, a SMS channel), generates the response 466, and generates a one-time pass code or key 467. The response and pass-code are sent 468 to the first communication channel 480.

The communication to the first communication channel 480 advises the user to trust a message to a second communication channel 481 only if it has the pass-code. For example, the second communication channel 481 may be an email system and the pass-code indicates tot the client that the email message is not fraudulent.

The message is sent 469 the client's second communication channel, and the message bears the non-OCR formatted pass-code 470 mentioned in the communication to the first communication channel 480 and a one-time-URL 471 valid only for the particular client.

The client links 473 to the secured-URL 472 and can trust it to be of the genuine service provider. As an extra security measure the client may enters his password 474 to the service provider 402 to complete the log on process.

The described methods and system is advantageous as the client validates the authenticity of the server by asking it questions with answers known only to the two entities. In one embodiment, the answers are not, and in fact cannot, be saved-away as they change all the time. For example the user can ask the service provider “when was the last time I logged on?” The answer to such a question is inherently known to the server and the answer changes over time.

The genuine service provider answers the question and also provides a non-OCR key to the user. The non-OCR key ensures that it is very hard for a man-in-the-middle computer to intercept and process the key. The client uses the key, potentially in addition to other known encryption techniques, e.g., PKI, to encrypt all the transactions from that point on. The non-OCR key is generated by the server on the fly for each session and it is not a saved secret.

The alternative-channel aspect provides a temporal (one time URL) just for that particular user. That URL can be trusted as it comes through the trusted alternative channel. Having such a mechanism adds another layer of security to the alternative channel.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for authentication carried out at a service provider, comprising:
starting a session with a client;
receiving a challenge from the client;
responding to the challenge with a response; and
sending a key to the client in non-OCR (optical character recognition) format, wherein the key is used for the session between the client and the service provider.

2. A method as claimed in claim 1, wherein the challenge from the client has a response inherently known to the service provider.

3. A method as claimed in claim 1, wherein the challenge and response are generated by a computer algorithm known to the client and the service provider.

4. A method as claimed in claim 1, wherein the challenge and response are generated by hardware tokens at the client and the service provider.

5. A method as claimed in claim 1, wherein the response has previously been provided by the client during a registration procedure with the service provider.

6. A method as claimed in claim 1, wherein the response is made to an alternative channel of communication with the client previously provided by the client.

7. A method as claimed in claim 1, wherein starting a session with a client includes receiving a log in request from a client, and the method includes a client sending a password only when the key has been received by the client and the password is encrypted with the key.

8. A method as claimed in claim 1, wherein the response and the key are provided in non-OCR format.

9. A method as claimed in claim 1, wherein the key is generated by the service provider at the time of the session.

10. A method as claimed in claim 1, wherein the key is a password, code or encryption key.

11. A method as claimed in claim 1, wherein the key gives access to an alternative address for the service provider.

12. A method as claimed in claim 11, including notifying the client by a first communication channel of the key, and sending to a second communication channel the non-OCR formatted key and the alternative address for the service provider.

13. A method for authentication carried out at a service provider, comprising:
starting a session with a client;
receiving a challenge from the client; and
responding to the challenge with a response to an alternative communication channel previously supplied by the client.

14. A method for authentication carried out at a service provider, comprising:
starting a session with a client;
receiving a challenge from the client;
responding to the challenge with a response; and
sending an alternative address for the service provider to the client.

15. A method as claimed in claim 14, wherein sending an alternative address for the service provider is through a trusted alternative channel.

16. A method as claimed in claim 14, wherein the alternative address is provided uniquely for the client.

17. A computer program product stored on a computer readable storage medium for, comprising computer readable program code means for performing the steps of:
starting a session with a client;
receiving a challenge from the client;
responding to the challenge with a response; and
sending a key to the client in non-OCR format, wherein the key is used for the session between the client and the service provider.

18. A system for authentication including a server comprising:
a receiving means for initiating a client session;
a response generating mechanism;
a key generator for a session key;
a non-OCR formatter for formatting the key;
a transmitting means for transmitting the response and the key to a client.

19. A system as claimed in claim 18, wherein the response generating mechanism determines a response inherently known at the server.

20. A system as claimed in claim 18, wherein the response generating mechanism includes a computer algorithm known to a client and the server.

21. A system as claimed in claim 18, wherein the response generating mechanism includes a hardware token corresponding to a hardware token of a client.

22. A system as claimed in claim 18, wherein the response generating mechanism includes a store of responses previously provided by a client.

23. A system as claimed in claim 18, wherein the response generating mechanism responds to an alternative channel of communication with a client previously provided by the client.

24. A system as claimed in claim 23, wherein the key is a password, code or encryption key.

25. A system as claimed in claim 24, wherein the key gives access to an alternative address for the service provider.

26. A system as claimed in claim 18, wherein the server includes an alternative address for a client session.

27. A system as claimed in claim 18, including a first communication channel for notifying the client of the key, a second communication channel for sending a non-OCR formatted key and the alternative address for the service provider.

28. A system as claimed in claim 27, wherein the second communication channel is a message means including a link to the alternative address for the service provider.
